(19) United States
(12) Patent Application Publication
(10) Pub. No.: US 2026/0111321 A1
(43) Pub. Date: Apr. 23, 2026

(54) CLOUD FAILURE REMEDIATION

(71) Applicant: Lenovo Enterprise Solutions (Singapore) Pte. Ltd., Singapore (SG)

(72) Inventors: Fred Allison Bower, III, Durham, NC (US); Caihong Zhang, Shanghai (CN); Jeffery J Van Heuklon, Rochester, MN (US); CheKim Chuuor, Shanghai (CN); Mark Edward Molander, Cary, NC (US)

(21) Appl. No.: 19/116,988

(22) PCT Filed: Jul. 12, 2023
(86) PCT No.: PCT/CN2023/106880

§ 371 Date: Mar. 28, 2025

(51) Int. Cl. G06F 11/20

(52) U.S. Cl. CPC G06F 11/2005

(57) ABSTRACT

A cloud failure remediation method comprises receiving a problem event from a problematic server running a work-load(301), creating a copy machine identical to the problematic server(302), transferring the workload from the problematic server to the copy machine(303), receiving an execution result of executing the workload from the copy machine(304), and generating a diagnosis result for the reported problem based on the execution result(305). The problem event indicates a reported problem occurred on the problematic server while running the workload.

### TECHNICAL FIELD

The present disclosure relates to enterprise and service systems and, more particularly, to a cloud failure remediation system and method for verifying problem resolution.

### BACKGROUND

Nowadays, cloud computing has become essential for most enterprises to lower their capital costs and day-to-day expenses. With the rise of the cloud, in all of its variations, cloud orchestration has increasing importance for managing multiple workloads across several cloud systems, for example, finding a best matching server across several cloud systems for each workload. One of the jobs of the cloud orchestration is to monitor the health of all of the hardware and the workloads and to diagnose any problems that arise. In conventional technologies, the cloud orchestration checks existing knowledge database storing match-up information between the workloads and hardware configurations, which includes inputs from analytics that are built upon the accumulated system events. This is a heuristic source of recommendations for further intervention. Given the workload diversity, the heuristic accuracy is limited in dynamic environments and needs a period of time to learn new configuration-based issues (i.e., the workload not being well matched to the hardware) via a training cycle.

### SUMMARY

In accordance with the disclosure, there is provided a cloud failure remediation method comprising receiving a problem event from a problematic server running a workload, creating a copy machine identical to the problematic server, transferring the workload from the problematic server to the copy machine, receiving an execution result of executing the workload from the copy machine, and generating a diagnosis result for the reported problem based on the execution result. The problem event indicates a reported problem occurred on the problematic server while running the workload.

Also in accordance with the disclosure, there is provided a cloud failure remediation system comprising a cloud system including a plurality of servers and a cloud orchestration host communicatively coupled to the cloud system. The cloud orchestration host is configured to receive a problem event from a problematic server running a workload, create a copy machine identical to the problematic server, transfer the workload from the problematic server to the copy machine, receive an execution result of executing the workload from the copy machine, and generate a diagnosis result for the reported problem based on the execution result. The problem event indicates a reported problem occurred on the problematic server while running the workload.

### BRIEF DESCRIPTION OF THE DRAWINGS

FIG. 1 is a schematic diagram showing a cloud failure remediation system for verifying problem resolution consistent with embodiments of the disclosure.

FIG. 2 is a schematic diagram showing a cloud orchestration host consistent with embodiments of the disclosure.

FIG. 3 is a flow chart illustrating a cloud failure remediation method for verifying problem resolution consistent with embodiments of the disclosure.

FIG. 4 is a flow chart illustrating another cloud failure remediation method for verifying problem resolution consistent with embodiments of the disclosure.

FIG. 5 is a flow chart illustrating another cloud failure remediation method for verifying problem resolution consistent with embodiments of the disclosure.

FIG. 6A is a flow chart illustrating another cloud failure remediation method for verifying problem resolution consistent with embodiments of the disclosure.

FIG. 6B is a flow chart illustrating another cloud failure remediation method for verifying problem resolution consistent with embodiments of the disclosure.

FIG. 6C is a flow chart illustrating another cloud failure remediation method for verifying problem resolution consistent with embodiments of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

In a cloud environment, a large number of hardware elements are running many different workloads. Because of the diversity of workloads run on the cloud and the frequent reconfiguration of the hardware, when receiving a problem event, a cloud orchestration may obtain an ambiguous result. That is, it is hard for the cloud orchestration to figure out whether the problem was because the workload wasn't well matched to the hardware (e.g., there are some mismatch in hardware configurations), or there actually is a hardware fault (e.g., a piece of hardware needs to be serviced by somebody out of a data center). In conventional technologies, the cloud orchestration has a knowledge base storing match-up information between the workloads and hardware configurations, which may include inputs form machine learning or analytic algorithms. However, a complete database or a complete population of match-up information cannot be obtained in a practical cloud environment.

The present disclosure provides a cloud failure remediation system and method for verifying problem resolution. The system can create an extra copy machine in the cloud environment that is identical to a server that reported a problem, and transfer the workload to the copy machine. If the problem can be reproduced in the copy machine, it means that the configurations plus the workload is a bad combination that should be avoided scheduling, otherwise, it is presumed that the original server reporting the fault has a problem. As such, the diagnosis of the problem described above can be automated to achieve a better sorting of which hardware needs to be quarantined versus which hardware needs to be reconfigured to better match the workload in the future.

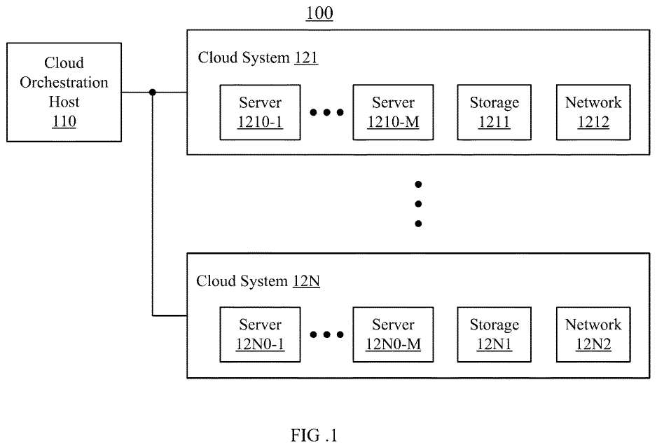

FIG. 1 is a schematic diagram of an example cloud failure remediation system 100 for verifying problem resolution consistent with the disclosure. As shown in FIG. 1, the cloud failure remediation system 100 includes a cloud orchestration host 110, and one or more cloud systems 121 to 12N communicatively coupled to the cloud orchestration host 110 through a data communication network. The one or more cloud systems 121 to 12N can include any type of clouds, for example, public clouds, private clouds, and hybrid clouds. Each cloud system can include a plurality of servers configured to execute workloads, a storage configured to store the workloads and coupled to the plurality of servers, and a network coupled to the plurality of servers. For example, as shown in FIG. 1, the cloud system 121 includes a plurality of servers 1210-1 to 1210-M, a storage 1211, and a network 1212. The cloud system 12N includes a plurality of servers 12N0-1 to 12N0-M, a storage 12N1, and a network 12N2.

The workload may be an instance of any application or task that can be executed by a server. For example, a workload may model complex systems, such as weather forecasting using a weather modeling application. As another example, the workload may include a video processing application to perform an object detection in the video, e.g., a real-time face tracker. Each server can execute one or more workloads, whether or not the workloads are virtualized. Each workload may have its own requirements on the hardware configurations of the server, including one or more hardware configurations that are needed to enable the workload to be executed or to support a desired performance of the workload. For example, the one or more hardware configurations may include parameter(s) associated with storage raid configuration, network adapter configuration, central processing unit (CPU) configuration, memory configuration, input/output (I/O) drivers' configuration, and/or the like. The one or more hardware parameter(s) may be any single parameter or any combination of parameters that affect the performance of the workload.

Each network (e.g., network 1212 or 12N2) can include a local area network (LAN), a wide area network (WAN), a virtual private network (VPN), and/or application programming interfaces (APIs) to connect the plurality of servers (e.g., servers 1210-1 to 1210-M, or servers 12N0-1 to 12N0-M) together.

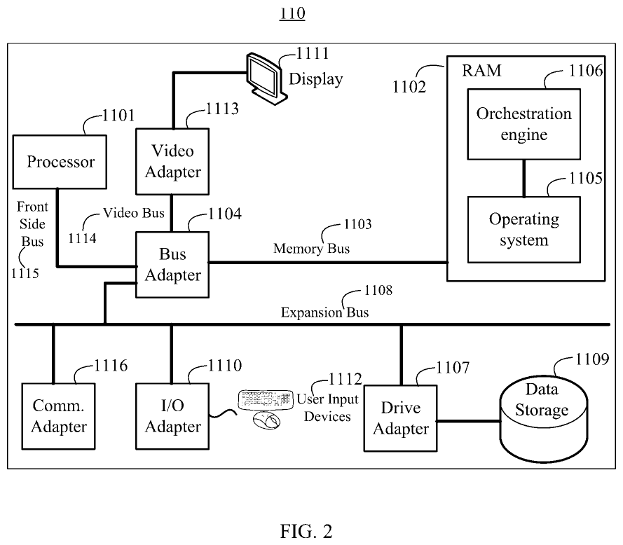

The cloud orchestration host 110 can include a platform or a server that can execute an orchestration engine or application. FIG. 2 is a schematic diagram of an example cloud orchestration host 110 consistent with the disclosure. As shown in FIG. 2, the cloud orchestration host 110 includes at least one processor 1101 and at least one random access memory (RAM) 1102 coupled to the processor 1101 through a high-speed memory bus 1103 and a bus adapter 1104.

The RAM 1102 can be configured to store an operating system 1105. The operating system 1105 can include UNIX, Linux, Microsoft Windows, AIX, and the like. In some embodiments, some components of the operating system 1105 can be stored in a non-volatile memory, for example, on a disk drive. The RAM 1102 can also be configured to store an orchestration engine 1106. The orchestration engine 1106 can include computer program instructions for managing the multiple workloads, in an automated fashion, across the one or more cloud systems 121 to 12N, for example, allocating each workload to a server matching the requirements of the workload. The orchestration engine 1106 can further include computer program instructions for performing the cloud failure remediation method for verifying problem resolution consistent with the disclosure.

The cloud orchestration host 110 further includes a disk drive adapter 1107 coupled to the processor 1101 and other components of the host 110 through an expansion bus 1108 and the bus adapter 1104. The expansion bus 1108 may be an interconnect fabric. The disk drive adapter 1107 can couple a non-volatile data storage 1109 to the cloud orchestration host 110 in the form of the disk drive. The disk drive adapter 1107 can include an Integrated Drive Electronics (IDE) adapter, a Small Computer System Interface (SCSI) adapter, or the like. The non-volatile data storage 1109 can include an optical disk drive, an electrically erasable programmable read-only memory (EEPROM), or the like.

The cloud orchestration host 110 further includes one or more input/output (I/O) adapters 1110. The one or more I/O adapters 1110 can implement user-oriented inputs/outputs through, for example, software drivers and/or computer hardware for controlling outputs to, e.g., a display device 1111 (e.g., a display screen or a computer monitor), and/or user inputs from, e.g., user input devices 1112 (e.g., a keyboard and mouse). The cloud orchestration host 110 further includes a video adapter 1113 configured for graphic output to the display device 1111. The video adapter 1113 is coupled to the processor 1101 through a high-speed video bus 1114, the bus adapter 1104, and a front side bus 1115.

The cloud orchestration host 110 further includes a communications adapter 1116 for data communications with a data communications network (e.g., IP data communications network or the like). The communications adapter 1116 can include a modem for wired dial-up communications, an Ethernet (IEEE 802.3) adapter for wired data communications, an 802.11 adapter for wireless data communication, or the like. The communications adapter 1116 can perform data communications of a hardware level, through which the cloud orchestration host 110 can send data to the one or more cloud systems 121 to 12N through the data communications network.

It is intended that modules and functions described in the example cloud orchestration host be considered as exemplary only and not to limit the scope of the disclosure. It will be appreciated by those skilled in the art that the modules and functions described in the example cloud orchestration host may be combined, subdivided, and/or varied.

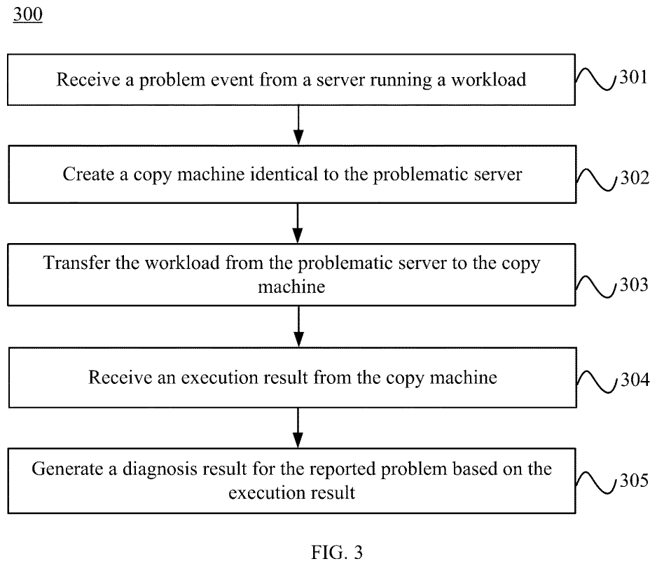

For further explanation, FIG. 3 sets for a flow chart illustrating an example cloud failure remediation method 300 for verifying problem resolution consistent with the disclosure. The method 300 can be implemented by a cloud orchestration host of the cloud failure remediation system for verifying problem resolution consistent with the disclosure, such as the cloud orchestration host 110 of the cloud failure remediation system 100 described above.

As shown in FIG. 3, at 301, a problem event is received from a server running a workload. When the server running the workload incurs a problem, the server can generate the problem event and send the problem event to the cloud orchestration host to report the problem. The problem event can include information about the reported problem. The server that incurs and reports the problem can also be referred to as a “problematic server.” The problematic server can be any server in a cloud system, for example, the server 1210-1 or 1210-M in the cloud system 121 described above. The cloud orchestration host can receive the problem event from the problematic server through a data communication network.

At 302, a copy machine identical to the problematic server is created. The cloud orchestration host can create the copy machine identical to the problematic server in response to receiving the problem event from the problematic server. In a cloud environment, there are generally multiple servers with the same hardware configurations. The cloud orchestration host can apply the firmware and configuration parameters of the problematic server to a server having the same hardware configurations in the cloud system as the problematic server to create the copy machine. That is, the copy machine can be the same as the problematic server at the firmware level in the cloud system. The hardware configurations can include parameters associated with the hyperthreading configuration, memory channel configuration, disk performance configuration, and/or the like.

At 303, the workload is transferred from the problematic server to the copy machine. The cloud orchestration host may initiate the transfer of the workload at any point after the copy machine is being created. When performing the transfer of the workload, the cloud orchestration host may also transfer an operation state of the workload over with the workload. The operation state of the workload may include accumulated memory defragmentation, CPU state, active network connections, active user sessions, opened files, and/or the like.

At 304, an execution result is received from the copy machine. Consistent with the disclosure, after the workload is transferred to the copy machine, the workload is executed by the copy machine. The workload may be executed by the copy machine for a period of time to check if the reported problem can be reproduced on the copy machine. In some embodiments, a length of the period of time should be enough for the copy machine to run the workload for an amount of time sufficient to establish a high-confidence result of either successful workload execution or failure. The copy machine can send the execution result of executing the workload to the cloud orchestration host.

At 305, a diagnosis result is generated for the reported problem based on the execution result. The diagnosis result can be based on whether the execution result indicates the reported problem is reproduced on the copy machine. In some embodiments, if the workload had the problem on the problematic server but the problem is not reproduced on the copy machine, it can be determined that the problematic server has a problem and the copy machine does not. Therefore, it can be the hardware, i.e., the problematic server, to have problem and not the workload. If the problem is present in both the problematic server and the copy machine, it can be determined that the hardware configurations of the problematic server may be incompatible with the workload. That is, if the reported problem is not reproduced on the copy machine, the diagnosis result can be that the reported problem is caused by a failure of the problematic server. On the other hand, if the reported problem being reproduced on the copy machine, the diagnosis result can be that the reported problem is tied to the hardware configurations plus the workload, e.g., the hardware configurations are not compatible with the workload.

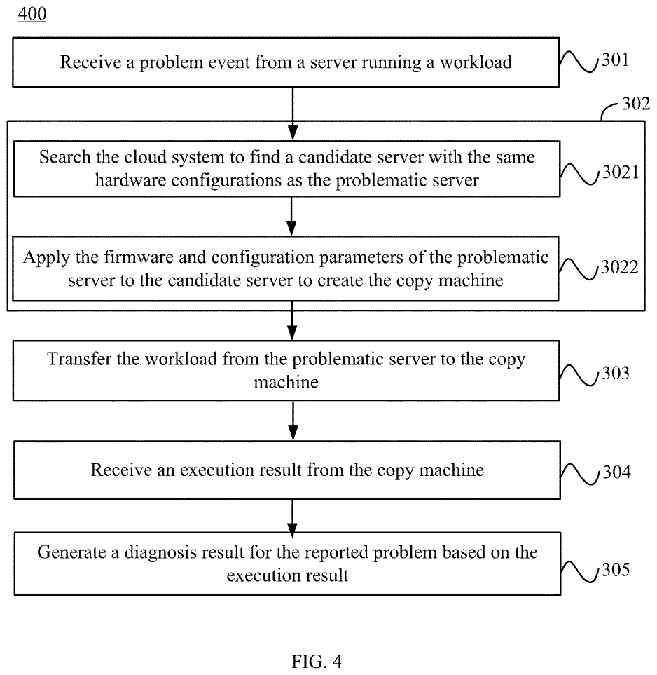

FIG. 4 is a flow chart illustrating an example cloud failure remediation method 400 for verifying problem resolution consistent with the disclosure. As shown in FIG. 4, the method 400 is similar to the method 300 in FIG. 3, except that in the method 400, creating the copy machine identical to the problematic server (i.e., the process at 302 in FIG. 3) further includes the following processes. At 3021, the cloud system is searched to find a candidate server with the same hardware configurations as the problematic server. The cloud orchestration host can search for the candidate server with the same hardware configurations as the problematic server from the cloud system. For example, if the problematic server has two CPUs, 1 terabyte (Tb) memory, and 5 attached drives, the cloud orchestration host can search the cloud system to find another server having two CPUs, 1 terabyte (Tb) memory, and 5 attached drives as the candidate server.

In a practical cloud system, there may be multiple servers having the same hardware configurations as the problematic server in the cloud system. In some embodiments, the cloud orchestration host can randomly select one server from the multiple servers as the candidate server. In some embodiments, the cloud orchestration host can select one server in an idle state from the multiple servers as the candidate server. In some other embodiments, the cloud orchestration host may send a transfer request to the multiple servers, and wait for a response from at least one of the multiple servers. The cloud orchestration host may select a server that sends the first response to the transfer request, i.e., the server that sends the response earliest in time, as the candidate server.

At 3022, the firmware and configuration parameters of the problematic server are applied to the candidate server to create the copy machine. The cloud orchestration host can read the firmware version and configuration parameters of the problematic server. The configuration parameters may include parameters associated with the hyperthreading configuration, memory channel configuration, disk performance configuration, and/or the like. If the firmware version of the candidate server is different from that of the problematic server, the cloud orchestration host can update the firmware of the candidate server accordingly, otherwise, the cloud orchestration host does not need to change the firmware of the candidate server. The cloud orchestration host can then set the configuration parameters of the candidate server to be the same as those of the problematic server to create the copy machine. As such, the copy machine can mimic the problematic server as much as possible.

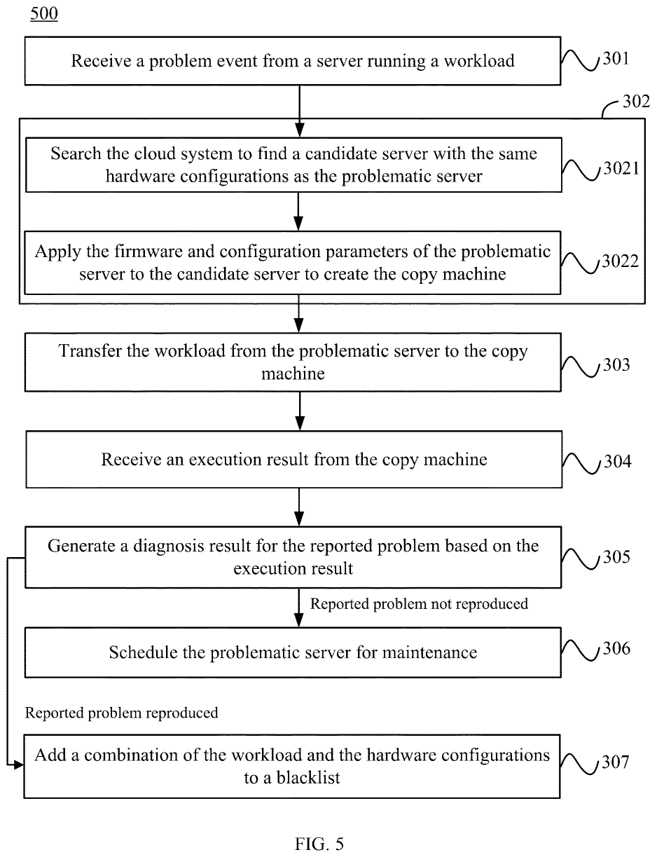

FIG. 5 is a flow chart illustrating an example cloud failure remediation method 500 for verifying problem resolution consistent with the disclosure. As shown in FIG. 5, the method 500 is similar to the method 400 in FIG. 4, except that the method 500 further includes the following processes. At 306, the problematic server is scheduled for maintenance in response to the reported problem being not reproduced. If the reported problem is not reproduced on the copy machine, it may mean that there is a failure of the problematic server, and thus the cloud orchestration host can put the problematic server into a repair-needed category pool and schedule the problematic server for maintenance, e.g., by someone out of the data center.

In some embodiments, if the problematic server is still in a live production, the cloud orchestration host may allow it to continue an operation, and put it into the repair-needed category pool after the problematic server finishes the operation. In some other embodiments, if the problematic server was put into a quarantine after reporting the problem, the cloud orchestration host may mark the problematic server as needing some repair and immediately put it into the repair needed category pool.

At 307, a combination of the workload and the hardware configurations is added to a blacklist in response to the reported problem being reproduced. If the reported problem is reproduced on the copy machine, it may mean that the problematic server has no problem and there may be a mismatch between the workload and the hardware configurations. The cloud orchestration host can add the combination of the workload and the hardware configurations to the blacklist on a database, such that the combination of the workload and the hardware configurations can be avoided for scheduling in the future, for example, until a resolution is available. If the problematic server was put into the quarantine after reporting the problem, the cloud orchestration host can further return the problematic server to a good hardware pool for other workloads.

Consistent with the disclosure, the cloud failure remediation method for verifying problem resolution can create a copy of the problematic server and check if the reported problem can be reproduced on the copy machine, and determine whether the reported problem is caused by the failure of the problematic server or by the mismatching between the hardware configurations and the workload. As such, an automated diagnosis of the reported problem can be realized. Therefore, the cloud system can work more efficiently, and hence, the provider of the cloud system can earn more profit as the same hardware is able to run more workloads.

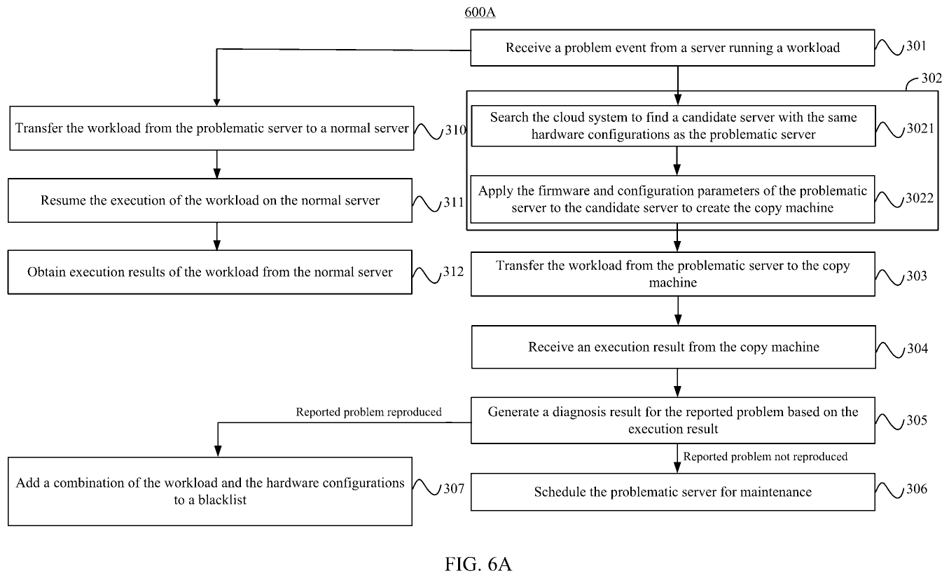

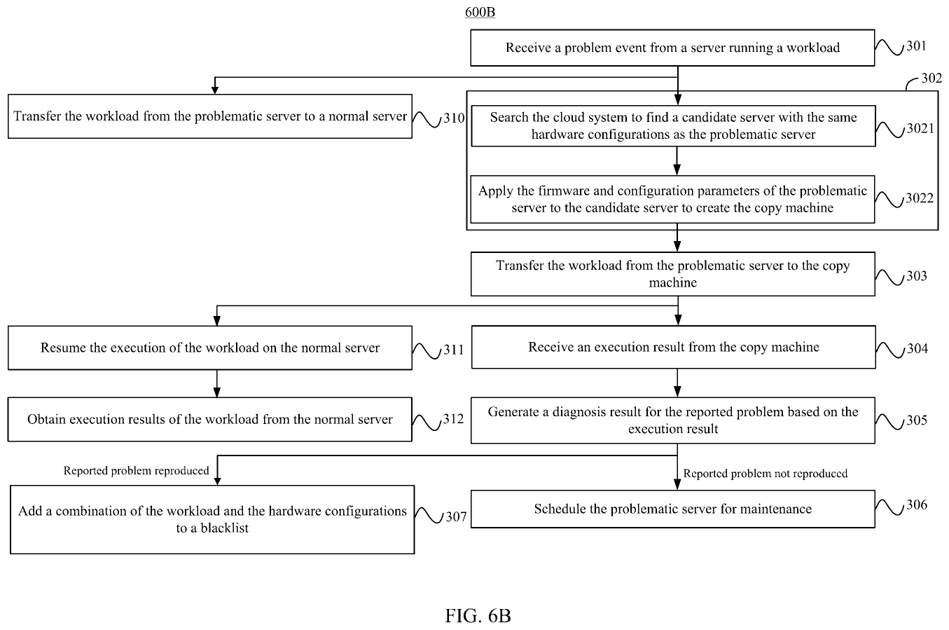

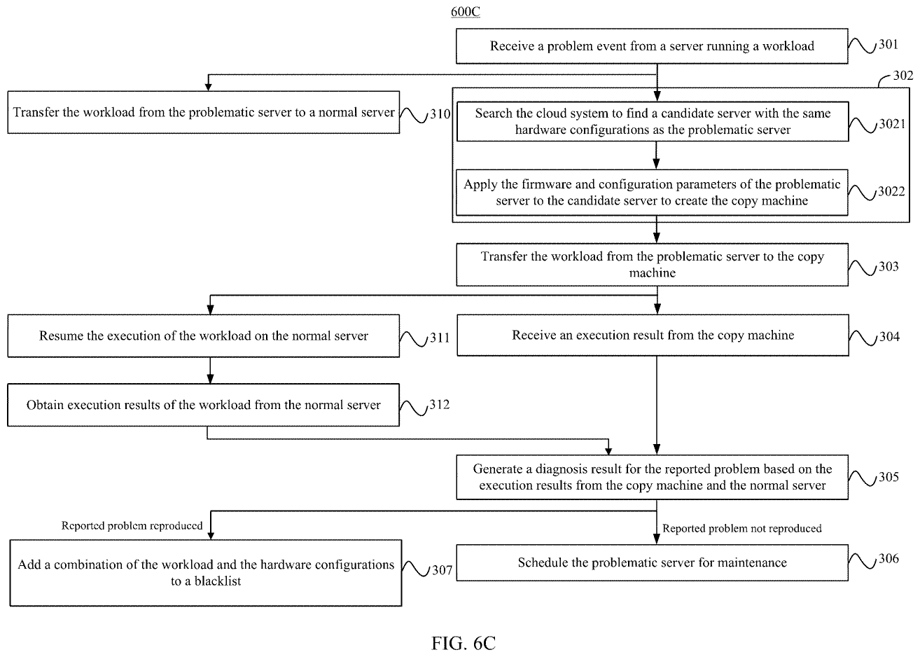

FIG. 6A is a flow chart illustrating an example cloud failure remediation method 600A for verifying problem resolution consistent with the disclosure. As shown in FIG. 6A, the method 600A is similar to the method 500 in FIG. 5, except that the method 600A further includes the following processes. At 310, the workload is transferred to a normal server. The cloud orchestration host can transfer the workload to the normal server in response to receiving the problem event from the problematic server. The normal server refers to a server having no problem. The normal sever can be a server selected from one or more servers satisfying the workload's requirements on the hardware configurations in a good hardware pool.

In some embodiments, the cloud orchestration host can randomly select one server from the one or more servers satisfying the workload's requirements on the hardware configurations in the good hardware pool. In some embodiments, the cloud orchestration host can select one server in an idle state from the one or more servers satisfying the workload's requirements on the hardware configurations in the good hardware pool. In some other embodiments, the cloud orchestration host may send a transfer request to the one or more servers satisfying the workload's requirements on the hardware configurations in the good hardware pool, and wait for a response from at least one of the servers in the good hardware pool. The cloud orchestration host may select a server that sends the first response to the transfer request, i.e., the server that sends the response earliest in time.

In some embodiments, the cloud orchestration host may also transfer the operation state of the workload over with the workload. The operation state of the workload may include accumulated memory defragmentation, CPU state, active network connections, active user sessions, opened files, and/or the like.

At 311, the execution of the workload is resumed on the normal server. The cloud orchestration host can resume the execution of the workload on the normal server after transferring the workload to the normal server.

At 312, execution results of the workload are obtained from the normal server. The cloud orchestration host can obtain the execution results of the workload from the normal server through the data communication network. The cloud orchestration host can further send the execution results of the workload to a customer who sends in the workload.

In some embodiments, the processes at 301, and 310 to 312 can be implemented in the main work flow and the processes at 302 to 307 can be implemented in a quarantine area or a bubble area that is designated to replay a sequence of problematic events, but not allowed to change customer data or communicate with the outside world. In this scenario, the processes at 310 and 302 can be implemented at the same time. As such, when the diagnosis processes (at 302 to 307 are implemented in the quarantine area or the bubble area, the execution of the workload (at 310 to 312) would not be interrupted.

FIG. 6B is a flow chart illustrating another example cloud failure remediation method 600B for verifying problem resolution consistent with the disclosure. The method 600B in FIG. 6B is similar to the method 600A in FIG. 6A. As shown in FIG. 6B, in some embodiments, the processes at 311 can be performed after the processes at 303. That is, after the workload is transferred from the problematic server to the copy machine at 303, the cloud orchestration host can resume the execution of the workload on the normal server at 311.FIG. 6C is a flow chart illustrating another example cloud failure remediation method 600C for verifying problem resolution consistent with embodiments of the disclosure. In some embodiments, as shown in FIG. 6C, at 305 the diagnosis result is generated for the reported problem based on the execution results from the copy machine and the normal server. That is, the cloud orchestration host can generate the diagnostic result for the reported problem based on the execution result from the copy machine and the execution results of the workload from the normal server. Thus, the processes at 305 can be performed after the processes at 304 and 312. For example, if the copy machine did not reproduce the reported problem and the workload runs normally at the normal server, it can be determined that the problematic server has a problem. If the problem is present in both the problematic server and the copy machine, but not on the normal server, it can be determined that the hardware configurations of the problematic server may be incompatible with the workload.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory.”

Program code embodied on a computer readable storage medium may be transmitted using any appropriate medium, including but not limited to wireless, wireline, optical fiber cable, RF, or the like, or any suitable combination of the foregoing. Computer program code for carrying out operations for aspects of the present disclosure may be written in any combination of one or more programming languages, including an object oriented programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “optionally,” “may,” and similar terms are used to indicate that an item, condition or step being referred to is an optional (not required) feature of the disclosure.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A cloud failure remediation method comprising:
receiving a problem event from a problematic server running a workload, the problem event indicating a reported problem occurred on the problematic server while running the workload;
creating a copy machine identical to the problematic server;
transferring the workload from the problematic server to the copy machine;
receiving, from the copy machine, an execution result of executing the workload; and
generating a diagnosis result for the reported problem based on the execution result.

2. The method of claim 1, wherein creating the copy machine identical to the problematic server includes:
searching a cloud system for a candidate server with same hardware configurations as the problematic server; and
applying a firmware and configuration parameters of the problematic server to the candidate server to create the copy machine.

3. The method of claim 2, wherein applying the firmware and the configuration parameters of the problematic server to the candidate server includes:
reading a firmware version and the configuration parameters of the problematic server;
updating a firmware of the server in response to the firmware version of the candidate server being different from a firmware version of the problematic server; and
setting the configuration parameters of the candidate server to be same as the problematic server.

4. The method of claim 2, wherein searching for the candidate server with the same hardware configurations as the problematic server includes:
searching the cloud system to find a plurality of servers with the same hardware configurations as the problematic server; and
selecting one server from the plurality of servers as the candidate server.

5. The method of claim 4, wherein selecting the one server from the plurality of servers includes:
selecting a server in an idle state from the multiple servers; or
selecting a server that sends a response to a transfer request earliest in time.

6. The method of claim 1, wherein transferring the workload from the problematic server to the copy machine includes:
transferring an operation state of the workload over with the workload.

7. The method of claim 1, wherein generating the diagnosis result for the reported problem includes:
determining that the reported problem is caused by a failure of the problematic server in response to the reported problem being not reproduced on the copy machine; and
determining that the reported problem is tied to a mismatch between hardware configurations and the workload in response to the reported problem being reproduced on the copy machine.

8. The method of claim 1, further comprising:
scheduling the problematic server for maintenance in response to the reported problem being not reproduced on the copy machine; and
adding a combination of the workload and hardware configurations to a blacklist in response to the reported problem being reproduced.

9. The method of claim 8, further comprising:
putting the problematic server into a repair-needed category pool in response to the reported problem being not reproduced; and
returning the problematic server to a good hardware pool for other workloads in response to the reported problem being reproduced.

10. The method of claim 1, further comprising:
transferring the workload to a normal server;
resuming an execution of the workload on the normal server; and
obtaining execution results of the workload from the normal server.

11. The method of claim 1, further comprising:
transferring the workload to a normal server in parallel with creating the copy machine identical to the problematic server in an isolated quarantine;
resuming an execution of the workload on the normal server; and
obtaining execution results of the workload from the normal server.

12. A cloud failure remediation system comprising:
a cloud system including a plurality of servers; and
a cloud orchestration host communicatively coupled to the cloud system and configured to:
receive a problem event from a problematic server running a workload, the problem event indicating a reported problem occurred on the problematic server while running the workload;
create a copy machine identical to the problematic server;
transfer the workload from the problematic server to the copy machine;
receive, from the copy machine, an execution result of executing the workload; and
generate a diagnosis result for the reported problem based on the execution result.

13. The system of claim 12, wherein the cloud orchestration host is further configured to:
search a cloud system for a candidate server with same hardware configurations as the problematic server; and
apply a firmware and configuration parameters of the problematic server to the candidate server to create the copy machine.

14. The system of claim 13, wherein the cloud orchestration host is further configured to:
read a firmware version and the configuration parameters of the problematic server;
update a firmware of the server in response to the firmware version of the candidate server being different from a firmware version of the problematic server; and
set the configuration parameters of the candidate server to be same as the problematic server.

15. The system of claim 13, wherein the cloud orchestration host is further configured to:
search the cloud system to find a plurality of servers with the same hardware configurations as the problematic server; and
select one server from the plurality of servers as the candidate server.

16. The system of claim 15, wherein the cloud orchestration host is further configured to:
select a server in an idle state from the multiple servers; or
select a server that sends a response to a transfer request earliest in time.

17. The system of claim 12, wherein the cloud orchestration host is further configured to:
transfer an operation state of the workload over with the workload.

18. The system of claim 12, wherein the cloud orchestration host is further configured to:
determine that the reported problem is caused by a failure of the problematic server in response to the reported problem being not reproduced on the copy machine; and
determine that the reported problem is tied to a mismatch between hardware configurations and the workload in response to the reported problem being reproduced on the copy machine.

19. The system of claim 12, wherein the cloud orchestration host is further configured to:
schedule the problematic server for maintenance in response to the reported problem being not reproduced on the copy machine; and
add a combination of the workload and hardware configurations to a blacklist in response to the reported problem being reproduced.

20. The system of claim 19, wherein the cloud orchestration host is further configured to:
put the problematic server into a repair-needed category pool in response to the reported problem being not reproduced; and
return the problematic server to a good hardware pool for other workloads in response to the reported problem being reproduced.

21. The system of claim 12, wherein the cloud orchestration host is further configured to:
transfer the workload to a normal server;
resume an execution of the workload on the normal server; and
obtain execution results of the workload from the normal server.

22. The system of claim 12, wherein the cloud orchestration host is further configured to:
transfer the workload to a normal server in parallel to create the copy machine identical to the problematic server in an isolated quarantine;
resume an execution of the workload on the normal server; and
obtain execution results of the workload from the normal server.
